(19) United States
(12) Patent Application Publication
(10) Pub. No.: US 2025/0312812 A1
(43) Pub. Date: Oct. 9, 2025

(54) EQUIPMENT FOR GLAZING MANUFACTURED ARTICLES

(71) Applicant: TECNO ITALIA DIGITAL S.R.L., Fiorano Modenese (MO) (IT)

(72) Inventor: Giancarlo FIANDRI, Fiorano Modenese (MO) (IT)

(21) Appl. No.: 18/860,546

(22) PCT Filed: Apr. 26, 2023
(86) PCT No.: PCT/IB2023/054302

§ 371 Date: Oct. 25, 2024

(30) Foreign Application Priority Data
Apr. 28, 2022 (IT) 102022000008447

(51) Int. Cl. B05C 5/02; B28B 11/04

(52) U.S. Cl. CPC B05C 5/0275; B28B 11/044

(57) ABSTRACT

The equipment for glazing manufactured articles, comprises: a load-bearing frame (2); movement means (3) of at least one manufactured article (M) to be decorated along one direction of forward movement (4); glazing means (5) of the manufactured article (M) to be decorated comprising—an internally hollow container (6) for the collection of glaze provided with at least one set of through orifices (7) for the outflow of the glaze, —at least one roller (8) housed inside the container (6) and operable in rotation around a relevant axis, wherein the volume positioned between the inner walls of the container (6) and the roller (8) defines a containment chamber (9) of the glaze, the roller (8) being provided with a set of projections (10) are adapted to open and close the orifices (7) in a sequential and cyclic manner respectively to allow and prevent the release of the glaze from the container (6); wherein the container (6) is provided with at least one pair of openings (11) communicating with the containment chamber (9) and it is movable in rotation with respect to the frame (2) between at least one work configuration and at least one unloading configuration so as to change the orientation of the openings (11).

### TECHNICAL FIELD

The present invention relates to a piece of equipment for glazing manufactured articles, particularly for glazing ceramic manufactured articles.

### BACKGROUND ART

Various methods and equipment are known to date for the decoration of manufactured articles and particularly for glazing ceramic manufactured articles.

A recently devised piece of equipment involves the use of a hollow container provided with a plurality of orifices within which a cylindrical roller is arranged provided with a series of projections adapted to sequentially open and close the orifices as a result of the rotation of the roller itself.

As a result of the rotation of the roller, then, the glaze contained within the hollow container flows out by gravity intermittently arranging itself onto the manufactured articles which are moved below the container itself.

Although this technology makes it possible to obtain uniform glazing of the manufactured articles and free of aesthetic defects, it does however have some drawbacks.

In particular, since there is often a need to make color changes to meet different production batches, it follows that the hollow container must be emptied from time to time from the glaze previously in use in order to carry out the subsequent introduction of a glaze having different characteristics. The hollow container must then also undergo a washing operation in order to prevent the previously contained glaze from contaminating the one that is subsequently introduced.

The operation of emptying the glaze can then be carried out either by making the glaze itself flowing out of the orifices or by suctioning it through pumping means. However, both of these methods are particularly uncomfortable and impractical, as well as ineffective.

Yet another drawback of the piece of equipment of known type described above is the difficulty of effectively washing the orifices through which the glaze flows out. This need is also felt during the decorating phases because accumulations of glaze can form at the orifices, which glaze can then fall onto the underlying manufactured articles, thus jeopardizing the proper glazing thereof.

Yet another drawback is the removal of condensation droplets that may form on the outer surface of the container during the decorating phases.

### DESCRIPTION OF THE INVENTION

The main aim of the present invention is to devise a piece of equipment for glazing manufactured articles which allows the type of glaze within the hollow container to be changed effectively and easily.

Within this aim, one object of the present invention is to carry out smooth and rapid emptying of the glaze contained within the hollow container. Another object of the present invention is to effectively wash the orifices through which the glaze is delivered.

Yet another object is to prevent any condensation droplets that form on the hollow container during the decorating phases from falling onto the manufactured articles below.

Another object of the present invention is to devise a piece of equipment for glazing manufactured articles which can overcome the aforementioned drawbacks of the prior art within the framework of a simple, rational, easy and efficient to use as well as cost-effective solution.

The aforementioned objects are achieved by this equipment for glazing manufactured articles according to claim 1.

### BRIEF DESCRIPTION OF THE DRAWINGS

Other characteristics and advantages of the present invention will become more apparent from the description of a preferred, but not exclusive, embodiment of a piece of equipment for glazing manufactured articles, illustrated by way of an indicative, yet non-limiting example, in the accompanying tables of drawings in which:

FIG. 1 is an axonometric view of a piece of equipment according to the invention with the container in the work configuration;

FIG. 2 is an axonometric view of the piece of equipment in FIG. 1 with the container in unloading configuration;

FIG. 2a is a magnifying view of a detail of the equipment in FIG. 2;

FIG. 3 is a rear elevation view of the equipment in FIG. 1;

FIG. 4 is a magnifying view of a detail of the equipment in FIG. 1;

FIG. 5 is an axonometric view of the glazing means of the equipment in FIG. 1;

FIG. 6 is a magnifying view of a detail of the glazing means in FIG. 5;

FIG. 7 is an exploded view of the glazing means in FIG. 5;

FIG. 8 is a longitudinal section of the glazing means in FIG. 5;

FIG. 9 is a cross section of the glazing means in FIG. 5.

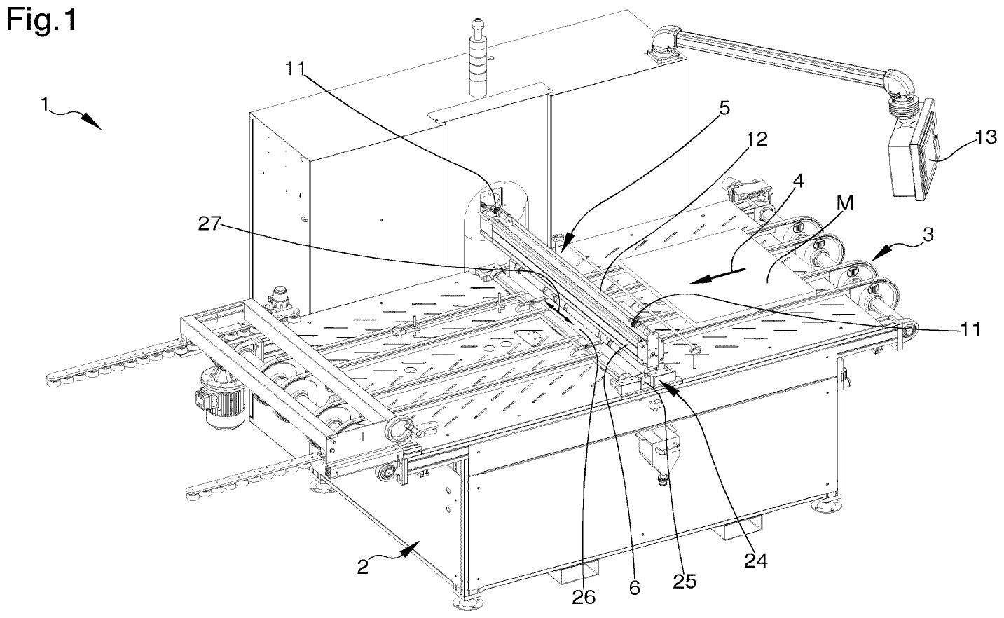

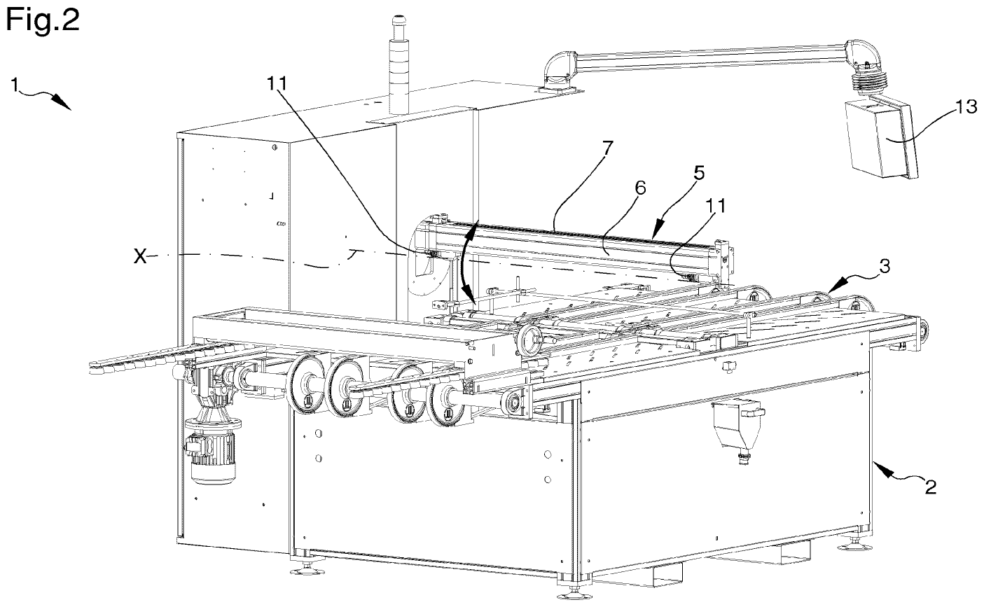

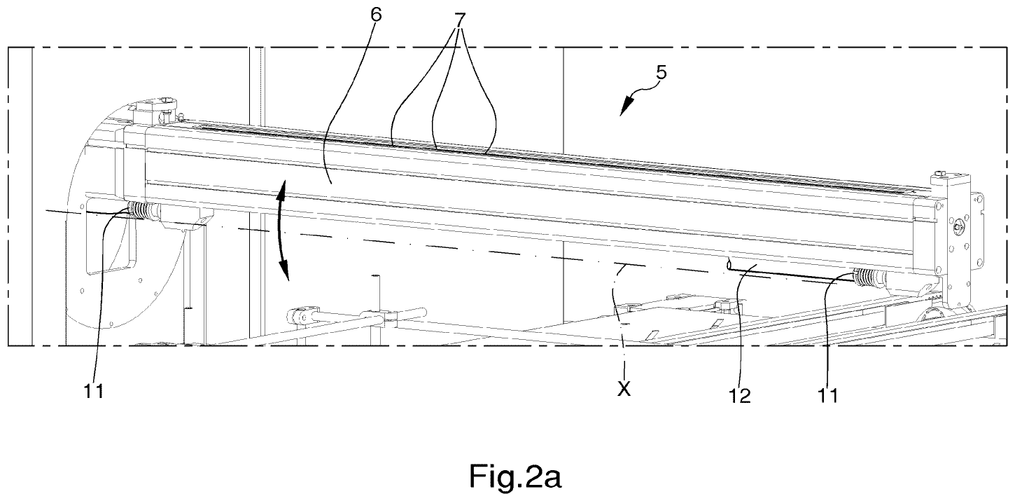

### EMBODIMENTS OF THE INVENTION

With particular reference to these figures, reference numeral 1 globally denotes a piece of equipment for glazing manufactured articles, particularly for glazing ceramic manufactured articles.

The equipment 1 comprises a load-bearing frame 2 arranged to rest on a base surface, movement means 3 of at least one manufactured article M to be decorated along one direction of forward movement 4 and glazing means 5 of the manufactured article M to be decorated. The movement means 3 define a resting plane of the manufactured article M and are made, e.g., of a plurality of motorized belts.

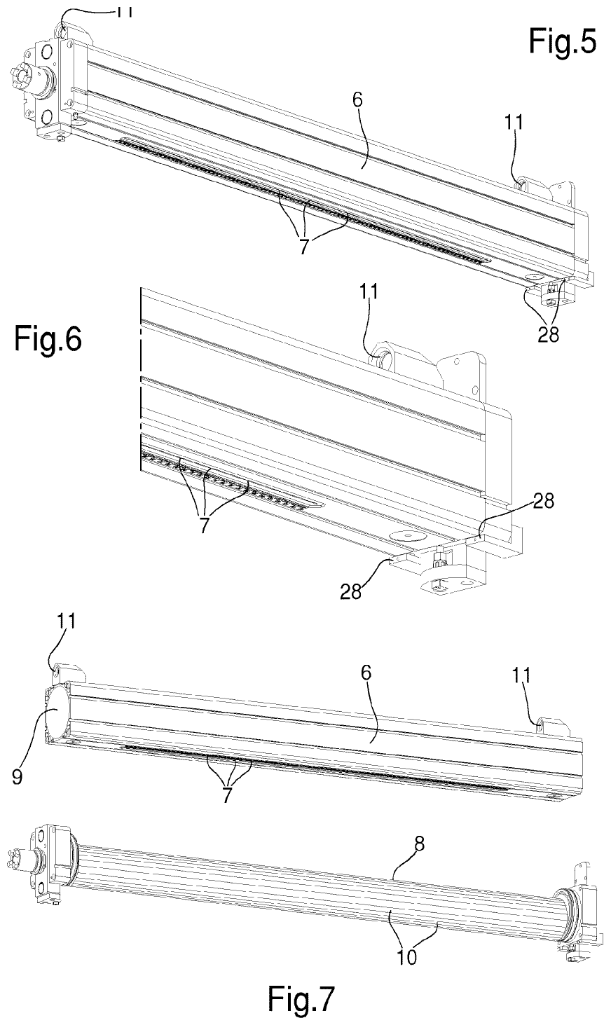

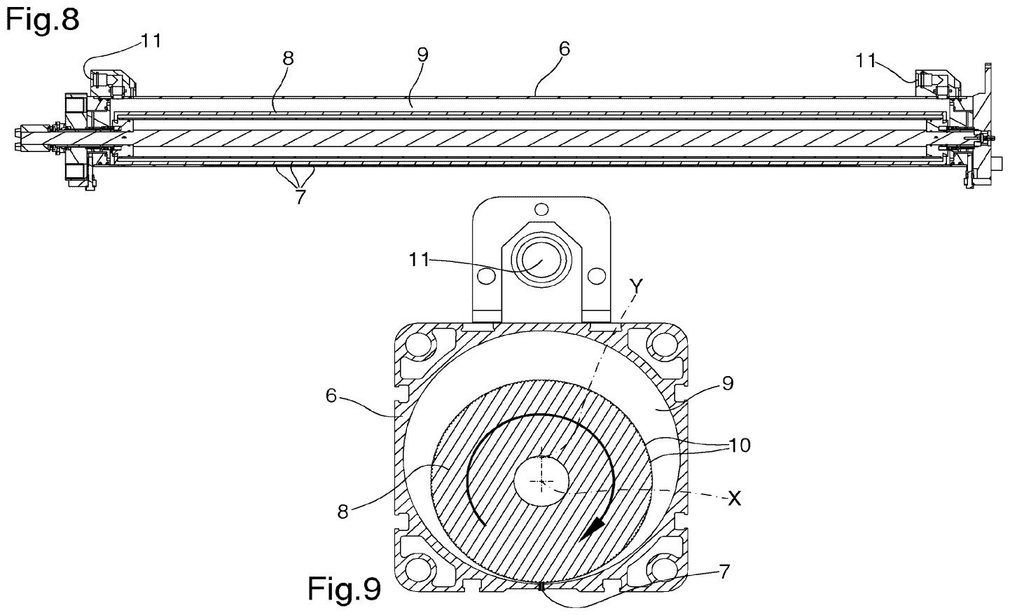

The glazing means 5 comprise an internally hollow container 6 for the collection of glaze to be applied onto the manufactured article M, having an elongated shape and being provided with at least one set of through orifices 7 for the outflow of the glaze. Inside the container 6 is housed at least one roller 8, which is operable in rotation around a relevant axis X, wherein the volume positioned between the inner walls of the container 6 and the roller 8 defines a containment chamber 9 of the glaze. The roller 8 is provided with a set of projections 10 which are angularly spaced from each other along the circular development of the roller itself which are adapted to open and to close the orifices 7 in a sequential and cyclic manner during the rotation of the roller 8 to allow and prevent the outflow of the glaze from the container 6, respectively. Therefore, through the orifices 7 glaze droplets are dispensed, resulting in a substantially point-like application on the manufactured article M. As the opening time of the orifices 7 increases, the size of the droplet delivered increases. As visible from FIGS. 5 and 7, the orifices 7 are aligned with each other parallel to the longitudinal development of the container 6.

According to the invention, the container 6 is provided with at least one pair of openings 11 communicating with the containment chamber 9.

In particular, the piece of equipment 1 is provided with at least one hydraulic circuit 12 for the passage of the glaze connected to the openings 11.

Also according to the invention, the container 6 is movable in rotation with respect to the frame 2 between at least one work configuration and at least one unloading configuration so as to change the orientation of the openings 11.

Preferably, in the work configuration, the openings 11 face upwards to allow the introduction of the glaze into the containment chamber 9, while in the unloading configuration, the openings 11 face downwards to facilitate the outflow of the glaze from the containment chamber 9. The positioning of the openings 11 downwards in the unloading configuration allows the glaze to flow out by gravity from the containment chamber 9 thus facilitating the emptying thereof.

Advantageously, the openings 11 are mutually arranged at the same height and mutually spaced along the longitudinal development of the container 6.

More particularly, the openings 11 are arranged at the point where two opposite longitudinal end stretches of the containment chamber 9 are located.

In the preferred embodiment shown in the figures, the openings 11 are arranged on opposite sides to the orifices 7, which are thus arranged downwards and facing the movement means 3 in the work configuration and arranged upwards in the unloading configuration. The orifices 7 are thus arranged in a substantially horizontal plane of lying and are aligned with each other transverse to the direction of forward movement 4 while the openings 11 are arranged along a plane parallel to the plane of lying of the orifices 7.

Alternative embodiments cannot however be ruled out wherein the at least one of the orifices 7 and the openings 11 are arranged in a different manner than that described above. In particular, at least one of either the orifices 7 or the openings 11 may be arranged at the point where a lateral wall of the container 6 is located, i.e., on a substantially vertical plane of lying.

The equipment 1 then comprises a receptacle for containing the glaze, not visible in detail in the figures. The hydraulic circuit 12 is set in communication with both such receptacle and with the openings 11, and pumping means 14 are arranged along the circuit which are adapted to transfer the glaze from the receptacle into the containment chamber 9 with the container 6 arranged in the work configuration.

Appropriately, the hydraulic circuit 12 is connectable, either manually or by means of the valve means not shown in detail in the figures, to the external environment so that the pumping means 14 convey air into the containment chamber 9 through one of the openings 11, so as to allow the outflow of the glaze contained in the containment chamber itself from the other of the openings 11, with the container 6 in the unloading configuration.

Preferably, the equipment 1 comprises motor means 15 connected to the frame 2 and connected to the container 6 in a kinematic manner to command the rotation thereof between the work configuration and the unloading configuration.

In addition, the equipment 1 comprises additional motor means 16 operationally connected to the roller 8 to command the rotation thereof within the containment chamber 9. The additional motor means 16 are locked together in rotation with the container 6 around the axis X in its displacement between the work configuration and the unloading configuration.

In more detail, the equipment 1 comprises a command and control unit 13, operationally connected to both the motor means 15 and the additional motor means 16.

Advantageously, the piece of equipment 1 also comprises adjustment means 17 for adjusting the distance of the container 6 from the movement means 3 in order to vary the distance between the orifices 7 and the manufactured article M.

In more detail, the piece of equipment 1 comprises at least one load-bearing body 18 which supports the container 6 in rotation and is associated movable by shift with the frame 2 along at least one substantially vertical direction of adjustment 19. The container 6 is locked together with the load-bearing body 18 along the direction of adjustment 19.

It follows, therefore, that the container 6 is movable in rotation with respect to the load-bearing body 18 around the axis X and is locked together with the same along the direction of adjustment 19.

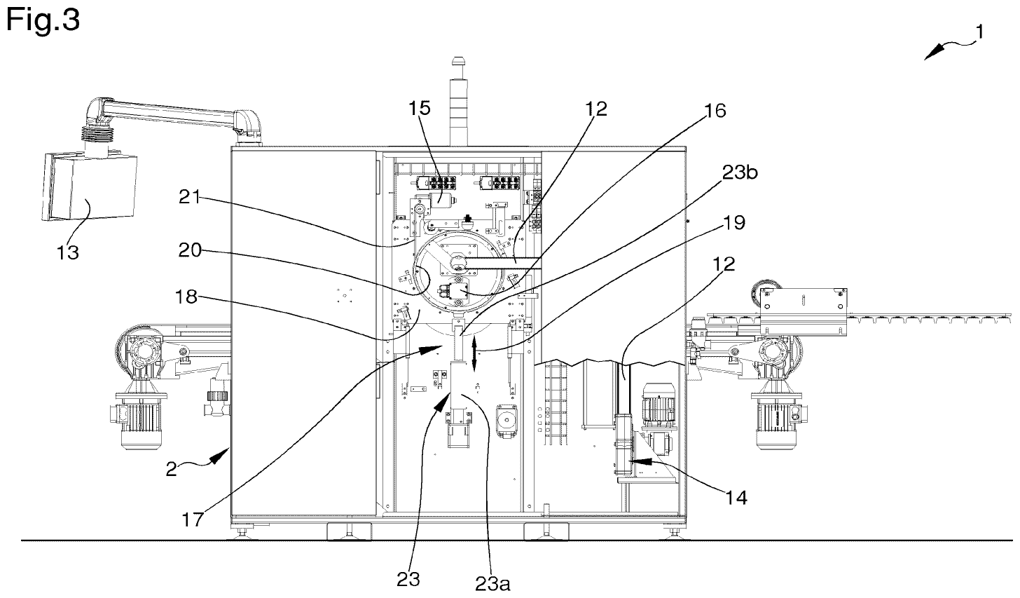

As can be seen from FIG. 3, the container 6 is locked together with a cylindrical body 20 which is connected to the motor means 15 in a kinematic manner by means of motion transmission means of the type of a toothed belt 21. Appropriately, the adjustment means 17 are adapted to move the load-bearing body 18 with respect to the frame 2 along the direction of adjustment 19.

More particularly, as can be seen from FIG. 3, the adjustment means 17 comprises at least one fluid-operated cylinder 23 having the body 23a associated with the frame 2 and the relevant stem 23b associated with the load-bearing body 18. As a result of the activation of the fluid-operated cylinder 23, therefore, the displacement of the stem 23b results in the movement of the load-bearing body 18, and thus also of the container 6, moving close to or away from the movement means 3.

Appropriately, the adjustment means 17 are also operationally connected to the command and control unit 13, which is therefore adapted to command the operation thereof.

As visible from FIG. 3, the motor means 15 are locked together with the load- bearing body 18 along the direction of adjustment 19. Similarly, the additional motor means 16 are locked together with the container 6.

Preferably, the equipment 1 comprises cleaning means 24 for cleaning the orifices 7.

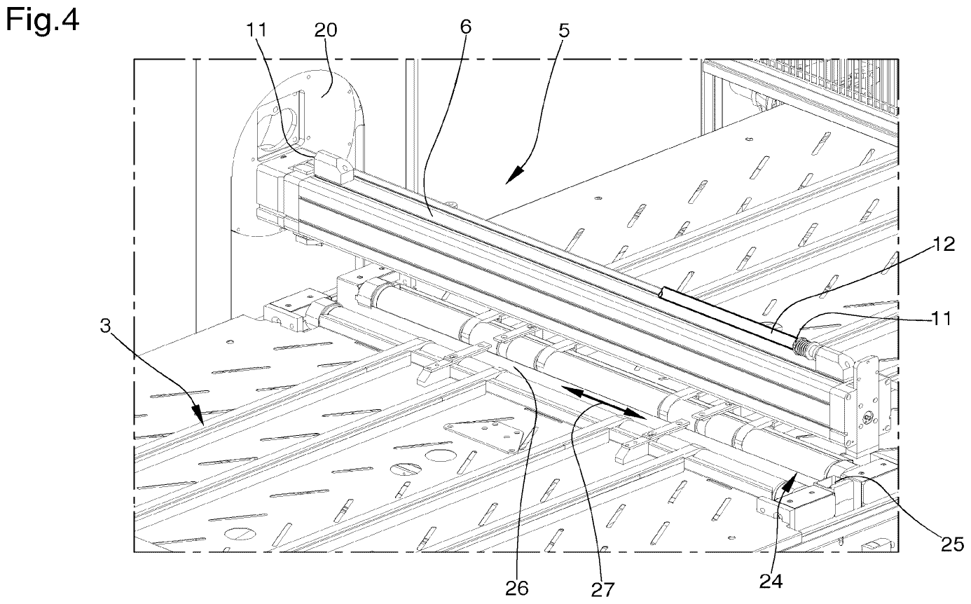

As can be seen in detail from FIG. 4, the cleaning means 24 comprise at least one nozzle 25 for the delivery of a washing fluid which is arranged inferiorly to the container 6, at the point where the orifices 7 are located, and which is movable by shift along a direction of washing 27 running parallel to the direction of alignment of the orifices 7. The direction of washing 27 is arranged transversely, and more particularly perpendicularly, to the direction of forward movement 4.

The nozzle 25 is then arranged at the point where the movement means 3 are located, below the resting plane defined by the same, and is movable along a track 26 arranged below the container 6 and substantially aligned with the orifices 7, with the container itself in the work configuration.

In more detail, the nozzle 25 is adapted to deliver a pressurized washing fluid during the forward stroke, so as to wash the overlying orifices 7 and a pressurized air flow during the return stroke to dry the orifices themselves.

Preferably, the glazing means 5 comprise at least one port 28 associated with the container 6 in the proximity of the orifices 7 and adapted to deliver pressurized air parallel to their direction of alignment.

The air delivered from the port 28 allows the removal of any condensation droplets that form on the outer surface of the container 6 during the decorating phase of the manufactured article M, thus preventing these from falling onto the underlying manufactured articles M.

In the preferred embodiment shown in FIG. 6, the equipment 1 comprises two ports 28 for delivering pressurized air arranged on opposite sides to the orifices 7.

The ports 28 are then arranged laterally with respect to the direction of alignment of the orifices 7.

The operation of this invention is as follows.

Initially the container 6 is placed in the work configuration and the roller 8 within it is arranged so that its projections occlude the orifices 7. At this point the glaze is introduced inside the containment chamber 9 through one of the openings 11 until it is completely filled. In this way, the air inside the containment chamber 9 flows out through the other opening 11.

Once the containment chamber 9 has been filled with glaze, it is possible to proceed with the decoration of the manufactured articles M passing underneath the container 6 as a result of the rotation of the roller 8.

As anticipated above, in fact, the projections 10 angularly spaced with each other along the circular development of the roller 8 open and close the orifices 7 in a sequential and cyclic manner during the rotation of the roller itself so as to allow and prevent the outflow of the glaze from the container 6, respectively. Appropriately, during the decorating phase, the glaze can be introduced inside the containment chamber 9 through both the openings 11.

In addition, during normal operation, as a result of any interruptions in the feeding flow of the manufactured articles M, e.g. due to a change in the production batch, the cleaning means 24 for cleaning the orifices 7 described above are activated.

Last but not least, between the decoration of two consecutive manufactured articles M, compressed air supply can be activated through the ports 28 in order to remove any condensation droplets on the lower surface of the container 6. Advantageously, depending on production requirements, it is then possible to adjust the distance of the container 6, and thus of the orifices 7, from the movement means 3. This adjustment is carried out through the adjustment means 17 which cause the load-bearing body 18 to move in a vertical direction. When the need arises to make a change in color or type of the glaze used, it is necessary to proceed with the emptying and subsequent washing of the containment chamber 9 from the glaze therein.

This operation is done by first bringing the container 6 to the unloading configuration, that is, by rotating it around the relevant axis X by 180° with respect to the work configuration. This results in the openings 11 facing downwards, thus facilitating the outflow by gravity of the glaze contained within the containment chamber 9. As described above, the rotation of the container 6 is carried out through the motor means 15.

Next, pressurized air is conveyed into the containment chamber 9 through the hydraulic circuit 12 so as to complete the emptying operation.

Once the containment chamber 9 and the hydraulic circuit 12 have been emptied of the glaze used up to that point, a washing operation is carried out by conveying pressurized water into the containment chamber itself and then letting it drain to the outside.

At the end of the washing phase, the equipment 1 is suitable to receive new glaze to resume the decoration of the manufactured articles M, so the container 6 is returned to the work configuration by operating again on the motor means 15.

It has in practice been ascertained that the described invention achieves the intended objects, and in particular, the fact is emphasized that the rotation of the container between the work configuration and the unloading configuration enables the easy and quick emptying of the containment chamber from the glaze therein.

In addition, the hydraulic circuit connected to the container and the cleaning means allow carrying out effective washing of the containment chamber and of the orifices from any glaze residue.

1. Equipment (1) for glazing manufactured articles, comprising:
a load-bearing frame (2);
movement means (3) of at least one manufactured article (M) to be decorated along one direction of forward movement (4);
glazing means (5) of the manufactured article (M) to be decorated comprising
an internally hollow container (6) for the collection of glaze, where said container (6) has an elongated shape and is provided with at least one set of through orifices (7) for the outflow of the glaze,
at least one roller (8) housed inside said container (6) and operable in rotation around a relevant axis, wherein the volume positioned between the inner walls of said container (6) and said roller (8) defines a containment chamber (9) of the glaze, said roller (8) being provided with a set of projections (10) angularly spaced from each other along the circular development of the roller itself which are adapted to open and close said orifices (7) in a sequential and cyclic manner respectively to allow and prevent the release of the glaze from said container (6);
characterized by the fact that said container (6) is provided with at least one pair of openings (11) communicating with said containment chamber (9) and by the fact that it is movable in rotation with respect to said frame (2) between at least one work configuration and at least one unloading configuration so as to change the orientation of said openings (11).

2. Equipment (1) according to claim 1, characterized by the fact that, in the work configuration, said openings (11) face upwards to allow the introduction of the glaze into said containment chamber (9) and by the fact that, in the unloading configuration, said openings (11) face downwards to facilitate the outflow of the glaze from said containment chamber (9).

3. Equipment (1) according to claim 1, characterized by the fact that said openings (11) are mutually arranged at the same height and mutually spaced along the longitudinal development of said container (6) and by the fact that said openings (11) are arranged at the point where two opposite longitudinal end stretches of said containment chamber (9) are located.

4. Equipment (1) according to claim 1, characterized by the fact that said openings (11) are arranged facing said orifices (7), the latter being arranged downwards and facing said movement means (3) in the work configuration and arranged upwards in the unloading configuration.

5. Equipment (1) according to claim 1, characterized by the fact that it comprises a receptacle for containing the glaze and a hydraulic circuit (12) communicating with said receptacle and with said openings (11), and by the fact that it comprises pumping means (14) arranged along said hydraulic circuit (12) for the transfer of the glaze from said receptacle into said containment chamber (9) with said container (6) in the work configuration.

6. Equipment (1) according to claim 5, characterized by the fact that said hydraulic circuit (12) is connectable to the external environment so that said pumping means (14) convey air into said containment chamber (9), through one of said openings (11), to allow the outflow of the glaze from the containment chamber itself through the other of said openings (11) with said container (6) in the unloading configuration.

7. Equipment (1) according to claim 1, characterized by the fact that it comprises motor means (15) connected to said frame (2) and connected to said container (6) in a kinematic manner to control the rotation thereof between said work configuration and said unloading configuration.

8. Equipment (1) according to claim 1, characterized by the fact that it comprises adjustment means (17) for adjusting the distance of said container (6) from said movement means (3).

9. Equipment (1) according to claim 8, characterized by the fact that it comprises at least one load-bearing body (18) which rotationally supports said container (6) and is associated movable by shift with said frame (2) along at least one substantially vertical direction of adjustment (19), said container (6) being locked together with said load-bearing body (18) along said direction of adjustment (19).

10. Equipment (1) according to claim 9, characterized by the fact that said adjustment means (17) are adapted to move said load-bearing body (18) with respect to said frame (2) along said direction of adjustment (19).

11. Equipment (1) according to claim 1, characterized by the fact that it comprises cleaning means (24) for cleaning said orifices (7).

12. Equipment (1) according to claim 11, characterized by the fact that said orifices (7) are aligned with each other along the longitudinal development of said container (6) and by the fact that said cleaning means (24) comprise at least one nozzle (25) for the delivery of a washing fluid arranged inferiorly to said container (6), at the point where said orifices (7) are located, and movable by shift along a direction of washing (27) running parallel to the direction of alignment of said orifices (7).

13. Equipment (1) according to claim 12, characterized by the fact that said direction of washing (27) is arranged transversely with respect to said direction of forward movement (4).

14. Equipment (1) according to claim 1, characterized by the fact that said glazing means (5) comprise at least one port (28) associated with said container (6) in the proximity of said orifices (7) and adapted to deliver pressurized air parallel to their direction of alignment.

15. Equipment (1) according to claim 14, characterized by the fact that it comprises at least two of said ports (28) arranged on opposite sides of said orifices (7).
